(19) United States
(12) Patent Application Publication
(10) Pub. No.: US 2019/0176087 A1
(43) Pub. Date: Jun. 13, 2019

(54) SCR-Active Material Having Enhanced Thermal Stability

(71) Applicant: Umicore AG & Co. KG, Hanau-Wolfgang (DE)

(72) Inventors: Frank Welsch, Rodenbach (DE); Michael Seyler, Mainaschaff (DE); Frank-Walter Schuetze, Aschaffenburg (DE); Stephan Eckhoff, Alzenau (DE)

(21) Appl. No.: 16/323,679

(22) PCT Filed: Aug. 11, 2017
(86) PCT No.: PCT/EP2017/070400

§ 371 Date: Feb. 6, 2019

(30) Foreign Application Priority Data
Aug. 11, 2016 (EP) 16183709.1

(51) Int. Cl. B01D 53/94; B01J 29/76; B01J 35/00; B01J 35/04; B01J 35/10; B01J 37/02; B01J 37/10; B01J 23/72; B01J 21/04; F01N 3/20

(52) U.S. Cl. CPC B01D 53/9418; B01J 2229/20; B01J 29/76; B01J 35/008; B01J 35/04; B01J 35/006; B01J 35/1019; B01J 35/1023; B01J 35/1028; B01J 37/0215; B01J 37/0236; B01J 37/10; B01J 23/72; B01J 21/04; F01N 3/2066; B01D 2255/50; B01D 2255/20761; B01D 2255/91; B01D 2255/2092; B01J 2229/183; B01J 2229/186; B01D 53/944

(57) ABSTRACT

The invention relates to an SCR-active material, comprising a small-pore zeolite of the structure type levyne (LEV), aluminum oxide, and copper, characterized in that, based on the total material, the material contains 4 to 25 wt % of aluminum oxide.

The present invention relates to an SCR-active material for reducing nitrogen oxides in the exhaust gas of combustion engines.

Exhaust gases from motor vehicles with a predominantly lean-operated combustion engine contain, in particular, the primary emissions of carbon monoxide CO, hydrocarbons HC, and nitrogen oxides NOx, in addition to particle emissions. Due to the relatively high oxygen content of up to 15 vol %, carbon monoxide and hydrocarbons can be made harmless relatively easily by oxidation. However, the reduction of nitrogen oxides into nitrogen turns out to be significantly more difficult.

A known method for removing nitrogen oxides from exhaust gases in the presence of oxygen is selective catalytic reduction (SCR method) by means of ammonia on a suitable catalyst. In this method, the nitrogen oxides to be removed from the exhaust gas are converted to nitrogen and water using ammonia. The ammonia used as reducing agent may be made available by feeding an ammonia precursor compound, e.g., urea, ammonium carbamate, or ammonium formate, into the exhaust gas stream, and by subsequent hydrolysis.

Certain metal-exchanged zeolites can be used as SCR catalysts, for example. Zeolites are often subdivided by the ring size of their largest pore openings into large-, medium-, and small-pore zeolites. Large-pore zeolites have a maximum ring size of 12, and medium-pore zeolites have a maximum ring size of 10. Small-pore zeolites have a maximum ring size of 8 and are, for example, of the levyne (LEV) structure type.

While SCR catalysts based upon iron-exchanged 13 zeolites, i.e., a large-pore zeolite, were, for example, used and are still being used to a large extent in the field of heavy-duty trucks, SCR catalysts based upon small-pore zeolites are becoming increasingly important; see, for example, WO 2008/106519 A1, WO 2008/118434 A1, and WO 2008/132452 A2. In particular, SCR catalysts on the basis of copper chabazite and copper levyne were most recently the focus in this respect.

The known SCR catalysts are indeed capable of converting nitrogen oxides with high selectivity, using ammonia as reducing agent, to nitrogen and water. However, from about 350° C., the so-called parasitic ammonia oxidation starts in catalysts based upon copper chabazite and copper levyne, and competes with the desired SCR reaction. In this case, the reducing agent, ammonia, is converted with oxygen to di-nitrogen monoxide (nitrous oxide), nitrogen monoxide, or nitrogen dioxide in a series of side reactions, so that either the reducing agent is not used effectively or additional amounts of nitrogen oxides form even from the ammonia. This competition is particularly pronounced at high reaction temperatures in the range of 500 to 650° C., as can occur in the regeneration of diesel particulate filters (DPF) in the exhaust gas line on the SCR catalyst. Furthermore, it must be ensured that the catalyst materials are stable to aging, in order to be able to achieve high pollutant conversions over the entire service life of a motor vehicle. In order to achieve high conversions even at the reaction temperatures of a DPF regeneration and over the service life, a need for improved SCR catalyst materials therefore exists.

WO 2008/132452 A2 describes a small-pore zeolite exchanged with, for example, copper, which can be coated as a washcoat onto a suitable monolithic substrate or extruded to form a substrate.

The washcoat may contain a binder selected from the group consisting of aluminum oxide, silica, (non-zeolitic) silica-alumina, natural clays, TiO₂, ZrO₂, and SnO₂.

WO 2013/060341 A1 describes SCR-active catalyst compositions from a physical mixture of an acidic zeolite or zeotype in protonic form or in iron-promoted form with, for example, Cu/Al₂O₃.

ACS Catal. 2012, 2, 1432-1440 describes reaction pathways of ammonia on CuO/_{γ}-Al₂O₃ during NH₃-SCR reactions. Whereas ammonia with 0.5 wt % CuO/_{γ}-Al₂O₃, in particular, reacted with nitrogen monoxide to form nitrogen, ammonia with 10 wt % CuO/_{γ}-Al₂O₃, in particular, reacts with oxygen to form nitrogen oxides.

It has now surprisingly been found that certain SCR materials based upon a small-pore zeolite of the levyne (LEV) structure type, aluminum oxide, and copper satisfy these requirements.

The present invention relates to an SCR-active material that comprises
a small-pore zeolite of the levyne (LEV) structure type,
aluminum oxide, and
copper,
   wherein the copper is present in a first concentration on the aluminum oxide and in a second concentration on the small-pore zeolite,
   characterized in that it contains 4 to 25 wt % aluminum oxide, relative to the total material.

The wording according to which copper is present on the small-pore zeolite of the levyne (LEV) structure type includes, within the scope of the present invention, the presence of copper as part of the lattice framework of the zeolite, the presence of copper in ion-exchanged form in pores of the zeolite skeleton, and any other form in which copper can be bound within the three-dimensional zeolite skeleton or on its surface.

The wording, according to which copper is present on the aluminum oxide, also encompasses all forms in which copper may be bound within the three-dimensional aluminum oxide skeleton or on its surface.

This also includes mixed oxides, such as copper alum inate (CuAl₂O₄).

The term, “copper,” in each case includes both metallic copper and copper in ion form, as well as copper oxide.

Furthermore, within the scope of the present invention, the term, “aluminum oxide,” does not include the proportion of aluminum oxide in the zeolite lattice of the zeolite. “Aluminum oxide” thus includes only the component according to (ii), and not the proportion of aluminum oxide resulting from the SiO₂/Al₂O₃ ratio (SAR) of the zeolite.

In an embodiment of the SCR-active material according to the invention, it contains 6 to 16 wt %—particularly preferably, 6 to 12 wt %—aluminum oxide, relative to the total material.

The total amount of copper, calculated as CuO and relative to the total SCR-active material, is, in particular, 0.5 to 15 wt %—preferably, 1 to 10 wt %, and, particularly preferably, 1.5 to 7 wt %.

It must be taken into account here that the preferred amount of copper in relation to the zeolite depends upon the SiO₂/Al₂O₃ ratio of the zeolite. Generally, as the SiO₂/Al₂O₃ ratio of the zeolite increases, the amount of exchangeable copper decreases. According to the invention, the preferred atomic ratio of copper exchanged in the zeolite to skeleton aluminum in the zeolite, hereinafter referred to as the Cu/Al ratio, is, in particular, 0.25 to 0.6. This corresponds to a theoretical degree of exchange of the copper with the zeolite of 50% to 120%, assuming a complete charge balance in the zeolite via bivalent Cu ions at a degree of exchange of 100%. Cu/AI values of 0.35-0.5, which corresponds to a theoretical degree of Cu exchange of 70-100%, are particularly preferred.

The Cu/AI ratio is a widely used quantity for characterizing zeolites exchanged with copper; see, for example, WO 2008/106519 A1, Catalysis Today 54 (1999) 407-418 (Torre-Abreu et al.), Chem. Commun., 2011, 47, 800-802 (Korhonen et al.), or ChemCatChem 2014, 6, 634-639 (Guo et al.). The person skilled in the art is thus familiar with this quantity. The Cu/AI ratio can be determined, for example, by means of optical emission spectrometry with inductively-coupled plasma (ICP-OES). This method is known to the person skilled in the art.

In a particular embodiment of the invention, the SCR-active material comprises a small-pore zeolite of the levyne (LEV) structure type, aluminum oxide, and copper, characterized in that it contains 5 to 25 wt % aluminum oxide relative to the total material, and the copper is present in a first concentration on the aluminum oxide and in a second concentration on the small-pore zeolite of the levyne (LEV) structure type.

It is particularly advantageous if the first concentration (the concentration of copper on the aluminum oxide) is higher than the second concentration (the concentration of copper on the small-pore zeolite of the levyne (LEV) structure type). The first concentration is preferably at least 1.5 times—particularly preferably, at least 3 times—higher than the second concentration. For example, the first concentration is 1.5 to 20 times or 3 to 15 times higher than the second concentration.

The ratio of the first and second concentrations can be determined using transmission electron spectroscopy (TEM) and energy-dispersive X-ray spectroscopy (EDX). To this end, a thin section of the SCR-active material according to the invention is produced, and the concentrations of copper in areas of the zeolite and in areas of the aluminum oxide are determined using EDX and put into proportion. This method is known to the person skilled in the art and described in the literature.

In an embodiment, the SCR-active material according to the invention is free of precious metals, such as platinum, palladium, and rhodium.

The small-pore zeolites of the levyne (LEV) structure type are, for example, aluminosilicates. These include naturally occurring, but preferably synthetically produced small-pore LEV zeolites. These are known to the person skilled in the art, for example, under the names, Nu-3, ZK-20, LZ-132, LZ-133, ZSM-45, RUB-50, SSZ-17, levynite, or levyne. In embodiments of the present invention, they have an SAR value of 5 to 50—preferably, 14 to 40, particularly preferably, 20 to 40, and, very particularly preferably, 30 to 40.

Within the scope of the present invention, the term, “small-pore zeolites of the levyne (LEV) structure type,” includes not only the above-described aluminosilicates, but also so-called zeolite-like materials of the type of silicoaluminophosphates (SAPO) and alum inophosphates (ALPO). Examples are SAPO-35, SAPO-67, and ALPO-35. For these materials, the preferred SAR values of aluminosilicates mentioned above are not applicable.

The average crystallite size (d₅₀) of the small-pore zeolite of the levyne (LEV) structure type is, for example, from 0.1 to 20 μm—preferably, 0.5 to 10 μm, and, particularly preferably, 1 to 4 μm.

The average crystallite size can be determined by scanning electron microscopy (SEM). This method is well known to the person skilled in the art.

Aluminum oxide with a BET surface area of 30 to 250 m²/g—preferably, 100 to 200 m²/g (determined according to ISO 9277)—is particularly suitable as aluminum oxide. Such materials are known to the person skilled in the art and are commercially available. In addition, aluminum oxides that are doped with further elements in order to improve or modulate the physical or chemical properties come into consideration. Known elements are, for example, Si, Mg, Y, La and elements of lanthanides, such as Ce, Pr, Nd, which can form mixed oxide compounds with the aluminum and can thus, for example, change the acidity or surface stability. The doping of the aluminum oxide with one or more elements should be less than 15 wt %—preferably, less than 10 wt %, and, particularly preferably, less than 5 wt %—relative to the respective mixed oxide. The aluminum oxides can be used as such, but it is preferred to form the aluminum oxide from a suitable precursor, such as a boehmite or aluminum salt, e.g., aluminum nitrate, within the scope of the production of the SCR-active material.

In an embodiment of the present invention, the SCR-active material is present in a form in which the small-pore zeolite of the levyne (LEV) structure type forms a core, and the aluminum oxide forms a shell surrounding this core. Such structures are known as core/shell structures and are described in, for example, WO 2012/117042 A2.

The SCR-active material according to the invention may, for example, be produced by drying and subsequently calcining an aqueous suspension of the small-pore zeolite of the levyne (LEV) structure type, copper salt, and aluminum oxide or a precursor compound of aluminum oxide.

For example, a small-pore zeolite of the levyne (LEV) structure type is provided in water, a soluble copper salt is added while stirring, and the aluminum oxide or a corresponding aluminum oxide precursor is subsequently added thereto. The resulting suspension of the SCR-active material according to the invention in water can be filtered and/or dried, for example.

In a further embodiment, the dried or moist, but free-flowing, small-pore zeolite of the LEV structure type can, in the form of an impregnation, according to the method of pore filling (incipient wetness), be mixed with the copper salt solution, e.g., by spraying in a suitable plowshare mixer, subsequently dried, and calcined. The aluminum oxide or aluminum oxide precursor may here be provided with the dry zeolite and/or be sprayed on in the form of a solution in order to obtain the SCR-active material according to the invention.

Preferred copper salts are salts that are soluble in water, such as copper sulfate, copper nitrate, and copper acetate. Copper nitrate and copper acetate are particularly preferred, and copper acetate is very particularly preferred.

The type of drying can be carried out by different methods. For example, spray drying, microwave drying, belt drying, roller drying, condensation drying, drum drying, freeze drying, and vacuum drying are known to the person skilled in the art. Spray drying, belt drying, roller drying, and freeze drying are preferred. Spray drying is particularly preferred. In this case, the suspension is introduced by means of an atomizer into a hot gas path, which dries it in a very short time (a few seconds to fractions of a second) to form the SCR-active material.

In a preferred embodiment, the SCR-active material is subsequently calcined in air or an air/water mixture—preferably, in an air/water mixture—at temperatures of 500° C.-900° C., for example. The calcination preferably takes place at temperatures between 600° C.-900° C.—particularly preferably, at 750° C.-900° C., and, very particularly preferably, between 800° C. and 900° C.

In a further embodiment of the present invention, it is possible—for example, after washing and drying and optionally calcining the aqueous suspension of the small-pore zeolite of the levyne (LEV) structure type and the copper salt (or an LEV already synthesized with copper)—to subsequently suspend the material thus obtained with aluminum oxide or a corresponding aluminum oxide precursor in aqueous solution, to dry and calcine again, and to thus produce the SCR-active material according to the invention. This material may subsequently be re-suspended in water, optionally milled, provided with binder, and coated onto a carrier substrate, for example. As binder for coating flow-through substrates, Al₂O₃, SiO₂, TiO₂, or ZrO₂ or their precursors, as well as mixtures thereof, for example, can be used. Binders are usually not required in the coating of filter substrates.

For the sake of clarity, it is pointed out here that the aluminum oxide or the aluminum oxide precursor for producing the SCR-active material according to the invention differs from aluminum-containing binder materials in that:
1. It is used in higher amounts than would be used by the person skilled in the art to achieve a higher adhesive strength of the washcoat components.
2. It is already used in the production of the SCR-active material, and not only to improve the adhesive strength of the catalytically-active material on a flow-through substrate.
3. A portion of the copper is present on the aluminum oxide.
4. The SCR-active material containing the aluminum oxide or aluminum oxide precursor is calcined before it is coated onto a substrate, whereby the typical binder properties are lost.
5. The aluminum oxide is also used for producing the SCR-active material according to the invention, if the porous walls of a filter substrate are to be coated (e.g., in the case of an in-wall coating of a wall-flow filter), in order to increase the thermal stability of the catalytically-active material. The use of a binder is not necessary in this case, since the binder properties of the binder are not required when the catalytically-active material is located in the pores of the filter. The additionally added binder would, furthermore, result in an undesirable increase in back pressure above the filter if the amount of the coated, catalytically-active material would have otherwise remained the same.
6. It contributes to increasing the NOx conversion after thermal aging of the SCR-active material according to the invention and is not deemed catalytically-inactive.

In this case, the SCR-active material according to the invention can satisfy one or more or all of the points mentioned above.

It is also, for example, possible, in a first step, to dry and optionally calcine the aqueous or wet suspension of the small-pore zeolite of the levyne (LEV) structure type, the copper salt, and a partial quantity of aluminum oxide or a precursor compound of aluminum oxide, and to subsequently, in a second step, re-suspend the material obtained with a corresponding further partial quantity of aluminum oxide or aluminum oxide precursor in aqueous solution, to dry and calcine it again, and to thus produce the SCR-active material according to the invention with the necessary total amount of Al₂O₃. Preferably, 25-80%—particularly preferably 40-70%—of the total aluminum oxide or aluminum oxide precursor (calculated as aluminum oxide) are already added during the first step.

The specific surface area of the SCR-active material according to the invention, determined by the BET method according to ISO 9277, has a specific surface area of over 400 m²/g—preferably, over 450 g/m², and, particularly preferably, over 450-600 m²/g—after 5 h of calcination in air at 950° C.

The material according to the invention is further characterized in that, after calcination in air at a temperature of 950° C. for 5 h, it has more than 80% of its original specific surface area, determined according to ISO 9277. The material according to the invention is preferably characterized in that, after calcination in air at a temperature of 1,000° C. for 5 h, it has more than 60% of its original specific surface area, determined according to ISO 9277.

In embodiments of the present invention, the SCR-active material according to the invention is present in the form of a coating on a carrier substrate.

Carrier substrates can be so-called flow-through substrates or wall-flow filters. They may consist, for example, of silicon carbide, aluminum titanate, cordierite, or metal. They are known to the person skilled in the art and are commercially available.

The application of the SCR-active material according to the invention to the carrier substrate can take place by methods known to the person skilled in the art, e.g., according to the usual dip-coating methods or pump-and-suck coating methods with subsequent thermal after-treatment (calcination), which preferably takes place at temperatures of 350-600° C.—particularly preferably, 400-550° C.

The person skilled in the art knows that, in the case of wall-flow filters, their average pore size and the average particle size of the SCR-active material according to the invention can be adapted to each other such that the resulting coating lies on the porous walls that form the channels of the wall-flow filter (on-wall coating). However, average pore size and average particle size are preferably adapted to one another such that the SCR-active material according to the invention is located in the porous walls that form the channels of the wall-flow filter, and that a coating of the inner pore surfaces thus takes place (in-wall coating). In this case, the average particle size of the SCR-active material according to the invention must be small enough to penetrate into the pores of the wall-flow filter.

If the SCR-active material according to the invention is present in the form of a coating on a carrier substrate, it can be present as a sole, catalytically-active coating, and then preferably extends over the entire length of the carrier substrate.

However, the SCR-active material according to the invention can also be present together with other catalytically-active coatings on a carrier substrate. In this case, the coating may also extend over the entire length of the carrier substrate or only over a section thereof.

The present invention also relates to embodiments in which the SCR-active material was extruded by means of a matrix component to form a substrate. The carrier substrate is in this case formed from an inert matrix component and the SCR-active material according to the invention.

Carrier substrates, flow-through substrates, and wall-flow substrates that do not just consist of inert material, such as cordierite, but additionally contain a catalytically-active material, are known to the person skilled in the art. To produce them, a mixture consisting of, for example, 10 to 95 wt % of an inert matrix component and 5 to 90 wt % of catalytically-active material is extruded according to a method known per se. All of the inert materials that are also otherwise used to produce catalyst substrates can be used as matrix components in this case. These are, for example, silicates, oxides, nitrides, or carbides, wherein, in particular, magnesium aluminum silicates are preferred.

The extruded carrier substrates comprising SCR-active material according to the invention may be used as such for exhaust gas purification. However, they can also be coated with further catalytically-active materials by customary methods, in the same way as inert carrier substrates.

The SCR-active material according to the invention may advantageously be used to purify exhaust gas from lean-operated combustion engines—particularly, diesel engines. It converts nitrogen oxides contained in the exhaust gas into the harmless compounds, nitrogen and water, and is particularly characterized by a high aging stability.

The present invention thus also relates to a method for purifying the exhaust gas of lean-operated combustion engines, characterized in that the exhaust gas is passed over an SCR-active material according to the invention.

As a rule, this passage occurs in the presence of a reducing agent. In the method according to the invention, ammonia is preferably used as reducing agent. For example, the required ammonia may be formed in the exhaust gas system upstream of the SCR-active material according to the invention, e.g., by means of an upstream nitrogen oxide storage catalyst (“lean NOx trap”—LNT). This method is known as “passive SCR.” However, ammonia may also be carried along in the “active SCR method” in the form of aqueous urea solution that is dosed in as needed via an injector upstream of the SCR-active material according to the invention.

The present invention thus also relates to a device for purifying exhaust gas from lean-operated combustion engines, characterized in that it comprises an SCR-active material according to the invention—preferably, in the form of a coating on an inert carrier material—as well as a means for providing a reducing agent.

Ammonia is generally used as reducing agent. In an embodiment of the device according to the invention, the means for providing a reducing agent is thus an injector for aqueous urea solution. The injector is generally fed with aqueous urea solution which originates from a carried-along reservoir, i.e, for example, a tank.

In another embodiment, the means for providing a reducing agent is a nitrogen oxide storage catalyst capable of forming ammonia from nitrogen oxide. Such nitrogen oxide storage catalysts are known to the person skilled in the art and are described comprehensively in the literature.

It is, for example, known from SAE-2001-01-3625 that the SCR reaction with ammonia proceeds more quickly if the nitrogen oxides are present in a 1:1 mixture of nitrogen monoxide and nitrogen dioxide, or in any case come close to this ratio. Since the exhaust gas of lean-operated combustion engines normally has an excess of nitrogen monoxide compared to nitrogen dioxide, the document proposes increasing the proportion of nitrogen dioxide with the aid of an oxidation catalyst.

In one embodiment, the device according to the invention thus also comprises an oxidation catalyst. In embodiments of the present invention, platinum on a carrier material is used as oxidation catalyst.

All materials that are known to the person skilled in the art for this purpose are considered as carrier materials. They have a BET surface area of 30 to 250 m²/g—preferably, of 100 to 200 m²/g (determined according to ISO 9277)—and are, in particular, aluminum oxide, silicon oxide, magnesium oxide, titanium oxide, zirconium oxide, cerium oxide, and mixtures or mixed oxides of at least two of these oxides. Aluminum oxide and aluminum/silicon mixed oxides are preferred. If aluminum oxide is used, it is, particularly preferably, stabilized—for example, with lanthanum oxide.

The device according to the invention is, for example, designed in such a way that in the direction of flow of the exhaust gas are arranged, first, the oxidation catalyst, then the injector for aqueous urea solution, and then the SCR-active material according to the invention—preferably, in the form of a coating on an inert carrier material. Alternatively, in the flow direction of the exhaust gas are arranged, first, a nitrogen oxide storage catalyst and then the SCR-active material according to the invention—preferably, in the form of a coating on an inert carrier material. In the regeneration of the nitrogen oxide storage catalyst, under reductive exhaust gas conditions, ammonia can be formed. In this case, the oxidation catalyst and injector for aqueous urea solution are dispensable.

The SCR-active material according to the invention surprisingly has advantages compared to conventional copper-exchanged, small-pore zeolites. In particular, it is distinguished by a significantly higher aging stability.

The invention is explained in more detail in the following examples and figures.

### EXAMPLE 1: PREPARATION OF A CATALYST EK1 ACCORDING TO THE INVENTION ON A FILTER SUBSTRATE

An aqueous suspension of copper-exchanged levyne (Cu-LEV, calcined at 850° C. for 2 h) with a SiO₂/Al₂O₃ ratio of 32 and a Cu content of 3.5 wt %, calculated as CuO relative to the zeolite, and a boehmite sol with a content of 20 wt % Al₂O₃ is produced so that the weight percentage of the cooper-exchanged levyne (LEV) is 88% and the weight percentage of Al₂O₃ is 12% in the dried material. The suspension is applied to a commercially available filter substrate in such a way that its loading after drying at 90° C. and calcination at 550° C. with dried material is 110 g/L of substrate volume.

### COMPARATIVE EXAMPLE 1: PREPARATION OF A COMPARATIVE CATALYST VK1 ON A FILTER SUBSTRATE

An aqueous suspension of copper-exchanged levyne (Cu-LEV, calcined at 850° C. for 2 h) with a SiO₂/Al₂O₃ ratio of 32 and a Cu content of 3.5 wt %, calculated as CuO relative to the zeolite, is produced. The weight percentage of the cooper-exchanged levyne (LEV) is 100%. The suspension is applied to a commercially available filter substrate in such a way that its loading after drying at 90° C. and calcination at 550° C. with dried material is 110 g/L of substrate volume.

Unlike example 1, no boehmite sol is added in comparative example 1.

### COMPARATIVE EXAMPLE 2: PREPARATION OF A COMPARATIVE CATALYST VK2 ON A FILTER SUBSTRATE

An aqueous suspension of copper-exchanged chabazite (Cu-CHA) with a SiO₂/Al₂O₃ ratio of 30 and a Cu content of 4.0 wt %, calculated as CuO relative to the zeolite, is produced. Added thereto is a boehmite sol with a content of 20 wt % Al₂O₃ so that the weight percentage of the cooper-exchanged chabazite (CHA) is 92.6% and the weight percentage of Al₂O₃ is 7.4% in the dried material. The suspension is applied to a commercially available filter substrate in such a way that its loading after drying at 90° C. and calcination at 550° C. with dried material is 110 g/L of substrate volume.

### EXAMPLE 2: VARIATION OF THE ALUMINUM OXIDE CONTENT IN THE CATALYSTS ACCORDING TO THE INVENTION (EK2 TO EK5) AND PREPARATION ON A FLOW-THROUGH SUBSTRATE

Produced are four aqueous suspensions of cooper-exchanged levyne (Cu-LEV, calcined for 2 hours at 850° C.) with a SiO₂/Al₂O₃ ratio of 32 and a Cu content of 3.5 wt %, calculated as CuO relative to the zeolite, and a boehmite sol with a content of 20 wt % Al₂O₃, such that the weight percentage of the cooper-exchanged levyne (Cu-LEV) X and the weight percentage of Al₂O₃ Y vary in the dried materials according to Table 1. The suspensions are each applied to a commercially available flow-through substrate so that the loading of the flow-through substrates after drying at 90° C. and calcination at 550° C. with dried material corresponds to the variable Z in g/L substrate volume. This is a coating with equivalent mass with respect to the cooper-exchanged levyne (Cu-LEV).

TABLE 1
Designations of the catalysts according to the invention,
as well as values of the variables X, Y, and Z

| | X Cu-LEV | Y Al₂O₃ | Z loading |
|---|---|---|---|
| Designation | [wt %] | [wt %] | [g/L] |
| EK2 | 88 | 12 | 112 |
| EK3 | 90 | 10 | 110 |
| EK4 | 92 | 8 | 108 |
| EK5 | 94 | 6 | 106 |

### EXAMPLE 3: VARIATION OF THE AL₂O₃ ADDITION TO FORM THE MATERIAL ACCORDING TO THE INVENTION (EK6)

A levyne (LEV) with a SiO₂/Al₂O₃ ratio of 32 is dispersed in an aqueous copper acetate solution and, after 3 h at 80° C. and cooling to room temperature, a boehmite sol with a content of 20 wt % Al₂O₃ is added. In this case, the amounts of reactant used are selected in such a way that, in the dried material, a Cu content of 3.5 wt %, calculated as CuO relative to the amount of levyne (LEV), is present, and the Al₂O₃ weight percentage, relative to the oxidic proportion of the total material, is 4%. With the material obtained after drying and calcining for 2 h at 850° C., an aqueous suspension is produced, with the addition of a boehmite sol with a content of 20 wt % Al₂O₃, so that the weight percentage of Al₂O₃ in the dried material according to the invention is 8%. The suspension is applied to a commercially available flow-through substrate in such a way that its loading after drying at 90° C. and calcining at 550° C. with dried material is 108 g/L substrate volume. This is thus the same loading as in the case of EK4. In contrast to EK4, the same total amount of Al₂O₃ is thus introduced into the material according to the invention in two steps.

### EXAMPLE 4: PREPARATION OF EK7 AND EK8 FOR SPECIFIC SURFACE AREA DETERMINATION ACCORDING TO THE BET METHOD

A levyne (LEV) with a SiO₂/Al₂O₃ ratio of 32 is dispersed in an aqueous copper acetate solution and, after 3 h at 80° C. and cooling to room temperature, a boehmite sol with a content of 20 wt % Al₂O₃ is added, and the mixture is dried.

In this case, the amounts of reactant used are selected in such a way that a Cu content of 3.5 wt %, calculated as CuO and relative to the amount of levyne (LEV), is present in the dried material, and the Al₂O₃ weight percentage, relative to the oxidic proportion of the total material, is 4% (EK7) or 8% (EK8).

After drying, the materials EK7 and EK8 produced were calcined for 5 h at 950° C. in air, and the specific surface area was measured according to ISO 9277. The results are presented in Table 2.

TABLE 2
Specific surface areas of EK7 and EK8
after calcination for 5 h at 950° C.

| Material | Specific surface areas [m²/g] |
|---|---|
| EK8 | 514 ± 10 |
| EK7 | 528 ± 10 |

### COMPARATIVE EXPERIMENTS: DETERMINATION OF THE NOX CONVERSION OF EK1, VK1, VK2, EK2 TO EK6

EK1 and VK1 were measured after preparation (fresh) and after aging in a hydrothermal atmosphere (10% H₂O, 10% O₂, remainder N₂). VK2 and EK2 to EK6 were measured only after preparation after aging in a hydrothermal atmosphere (10% H₂O, 10% O₂, remainder N₂). The holding times and aging temperatures for EK1, VK1, and VK2 were 4 h at 900° C. and 1 h at 950° C. EK2 to EK5 were aged only for 1 h at 950° C. in hydrothermal atmosphere.

The NOx conversion of the catalysts EK1, VK1, VK2, and EK2 to EK5 as a function of the temperature upstream of the catalyst was determined in a model gas reactor in the so-called NOx conversion test.

This NOx conversion test consists of a test procedure that comprises a pre-treatment and a test cycle that is run through for various target temperatures. The applied gas mixtures are noted in Table 3.

Test Procedure:
1. Preconditioning at 600° C. in N₂ for 10 min
2. Test cycle repeated for the target temperatures
   a. Approaching the target temperature in gas mixture 1
   b. Addition of NOₓ (gas mixture 2)
   c. Addition of NH₃ (gas mixture 3), wait until NH₃ breakthrough >20 ppm, or a maximum of 30 min. in duration
   d. Temperature-programmed desorption up to 500° C. (gas mixture 3)

TABLE 3
Gas mixtures of the NOx conversion test.

| | | | |
|---|---|---|---|
| Gas mixture | 1 | 2 | 3 |

| | | | |
|---|---|---|---|
| N₂ | Balance | Balance | Balance |

| | | | | | | |
|---|---|---|---|---|---|---|
| O₂ | 10 | vol % | 10 | vol % | 10 | vol % |
| NOx | 0 | ppm | 500 | ppm | 500 | ppm |
| NO₂ | 0 | ppm | 0 | ppm | 0 | ppm |
| NH₃ | 0 | ppm | 0 | ppm | 750 | ppm |
| CO | 350 | ppm | 350 | ppm | 350 | ppm |
| C₃H₆ | 100 | ppm | 100 | ppm | 100 | ppm |
| H₂O | 5 | vol % | 5 | vol % | 5 | vol % |

The space velocity in the case of the measurements of EK2 to EK6 was at a space velocity (GHSV) of 60,000 h⁻¹. In the case of EK1, VK1, and VK2, the NOx conversion was determined at 500° C. at a space velocity (GHSV) of 60,000 h⁻¹. From 500° C., the space velocity (GHSV) was 100,000 h⁻¹.

For each temperature point below 500° C., the conversion with an NH₃ slip of 20 ppm is determined for test procedure range 2c. For each temperature point above 500° C., the conversion in a state of equilibrium is determined in the test procedure range 2c. Plotting this NOx conversion for the various temperature points results in a plot as shown in FIGS. 1, 3, and 4.

Comparison of the Catalytic Activity of EK1 and VK1, as Well as VK2:

FIG. 1 shows that EK1, in comparison to VK1, has significantly improved NOx conversions over the temperature range under consideration after hydrothermal aging for 4 h at 900° C. and, particularly clearly, after hydrothermal aging for 1 h at 950° C. This is due to the material according to the invention produced by adding Al₂O₃.

FIG. 4 shows that the NOx conversions of VK2 after both aging conditions are substantially below those of EK1 and EK4 (after hydrothermal aging for 1 h at 950°).

Comparison of the Catalytic Activity of EK2 to EK5:

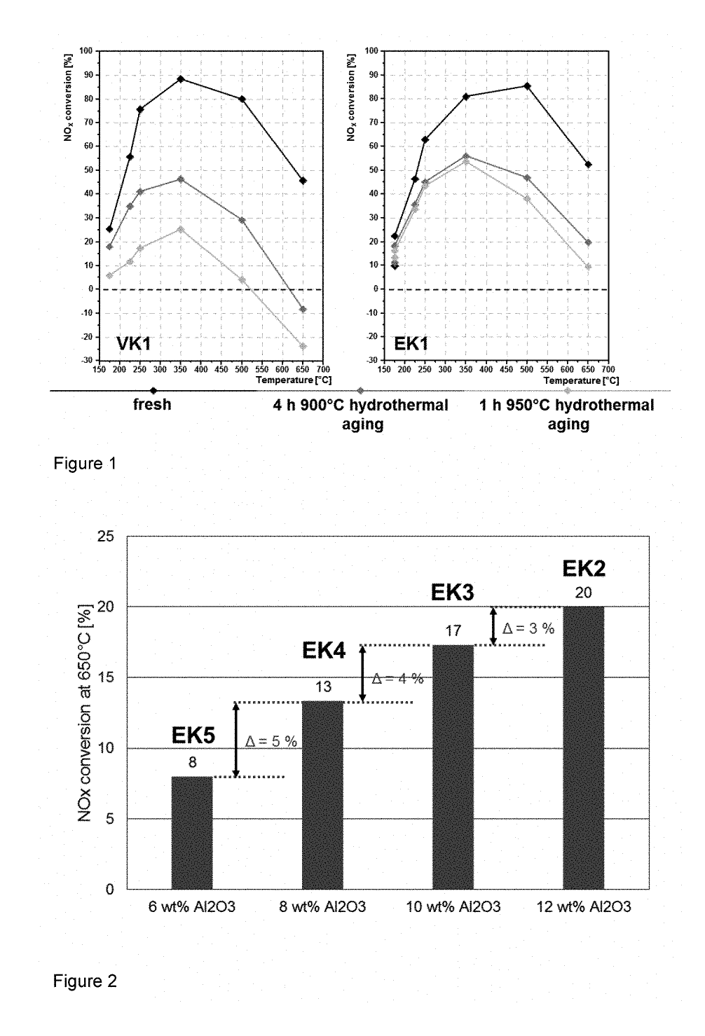

FIG. 2 shows that, after hydrothermal aging for 1 h at 950° C., stabilization of the NOx conversion at 650° C., with increasing Al₂O₃ weight proportion of EK5 to EK2 in the formed materials according to the invention, takes place.

Comparison of the Catalytic Activity of EK4 and EK6:

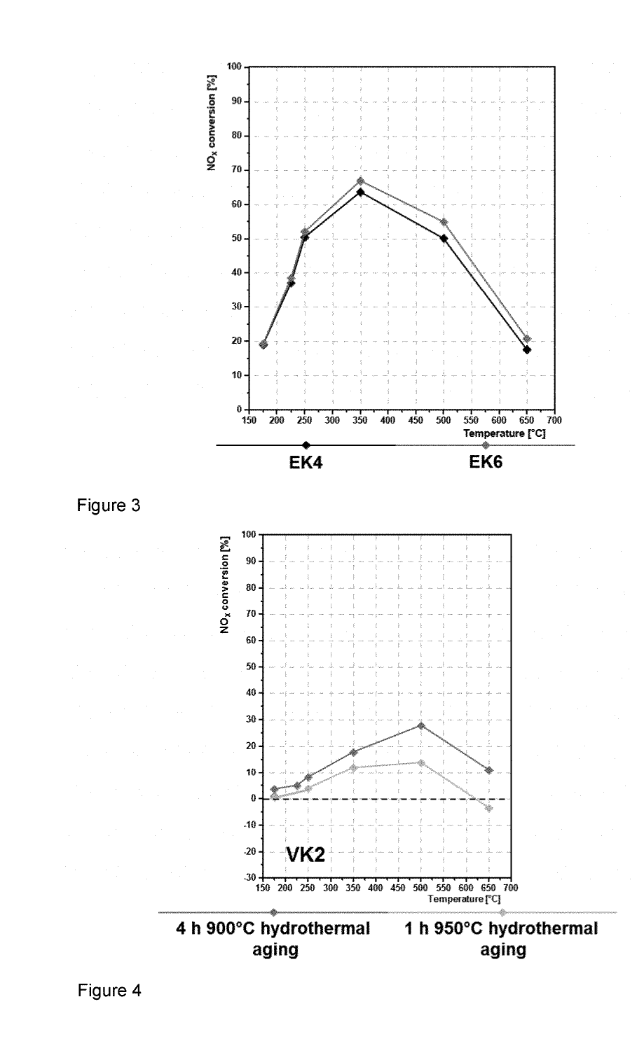

FIG. 3 shows that, after hydrothermal aging for 1 h at 950° C., a further stabilization of the NOx conversion of the material according to the invention in EK4 is obtained in the temperature range above 350° C., when the addition of Al₂O₃, as shown with the material according to the invention in EK6, takes place in the steps described.

1. An SCR-active material comprising
(i) a small-pore zeolite of the levyne (LEV) structure type,
(ii) aluminum oxide, and
(iii) copper,
wherein the copper is present in a first concentration on the aluminum oxide and in a second concentration on the small-pore zeolite,
wherein it contains 4 to 25 wt % aluminum oxide, relative to the total SCR-active material.

2. The SCR-active material according to claim 1, wherein it contains 6 to 16 wt % aluminum oxide, relative to the total SCR-active material.

3. The SCR-active material according to claim 1, wherein the total amount of copper, calculated as CuO and relative to the total SCR-active material, is 0.5 to 15 wt %.

4. The SCR-active material according to claim 1, wherein the small-pore zeolite of the levyne (LEV) structure type is an aluminosilicate.

5. The SCR-active material according to claim 4, wherein the small-pore zeolite of the levyne (LEV) structure type has an SAR value of 5 to 50.

6. The SCR-active material according to claim 1, wherein the small-pore zeolite of the levyne (LEV) structure type is a silicoaluminosilicate or an aluminophosphate.

7. The SCR-active material according to claim 1, wherein the atomic ratio of copper exchanged in the zeolite to skeleton aluminum in the zeolite is 0.25 to 0.6.

8. The SCR-active material according to claim 1, wherein the average crystallite size (d₅₀) of the small-pore zeolite of the levyne (LEV) structure type is 0.1 to 20 μm.

9. The SCR-active material according to claim 1, wherein the small-pore zeolite of the levyne (LEV) structure type forms a core, and the aluminum oxide forms a shell surrounding this core.

10. The SCR-active material according to claim 1, wherein its specific surface area, determined according to ISO 9277, after calcination at 950° C. for 5 hours is above 400 m²/g.

11. The SCR-active material according to claim 1, wherein the first concentration is higher than the second concentration.

12. The SCR-active material according to claim 1, wherein the first concentration is at least 1.5 times higher than the second concentration.

13. The SCR-active material according to claim 1, wherein it is present in the form of a coating on a carrier substrate or that it was extruded by means of a matrix component to form a substrate.

14. A method for purifying exhaust gas of lean-operated combustion engines, wherein the exhaust gas is passed over an SCR-active material according to claim 1.

15. A device for purifying exhaust gas from lean-operated combustion engines, wherein it comprises an SCR-active material according to claim 1, as well as a means for providing a reducing agent.

16. The device according to claim 15, wherein the means for providing a reducing agent is an injector for aqueous urea solution.

17. The device according to claim 15 and/or 16, wherein it comprises an oxidation catalyst.

18. The device according to claim 15, wherein the means for providing a reducing agent is a nitrogen oxide storage catalyst.

19. A method for producing the SCR-active material according to claim 1, wherein an aqueous suspension of a small-pore zeolite of the levyne (LEV) structure type, copper salt, and aluminum oxide or a precursor compound of aluminum oxide is dried and subsequently calcined.

20. The method according to claim 19, wherein the drying is spray drying.

21. The method according to claim 19, wherein the calcination takes place in air or in an air/water atmosphere at temperatures between 700° C. and 900° C.
